(19) United States
(12) Patent Application Publication
(10) Pub. No.: US 2025/0286290 A1
(43) Pub. Date: Sep. 11, 2025

(54) ELECTRICAL CONNECTION STRUCTURE

(71) Applicant: HONDA MOTOR CO., LTD., Tokyo (JP)

(72) Inventor: Takahiro HAGIMOTO, Saitama (JP)

(21) Appl. No.: 19/050,303

(22) Filed: Feb. 11, 2025

(30) Foreign Application Priority Data
Mar. 5, 2024 (JP) 2024-033160

(51) Int. Cl. H01R 4/34; H01B 5/02; H01R 4/30

(52) U.S. Cl. CPC H01R 4/34; H01B 5/02; H01R 4/305

(57) ABSTRACT

An electrical connection structure includes a first male screw, a first collar and a first threaded member. A circuit unit is mounted on a machine base. The first male screw projects upwards from an end part of the machine base adjacent to a capacitor unit. The first collar is an electric conductor having female threads in both upper and lower sides, and the lower part thereof is threaded to the first male screw. The first threaded member fastens the first bus bar to an upper part of the first collar so that this first bus bar is positioned above the capacitor unit. A second bus bar is arranged similarly.

This application is based on and claims the benefit of priority from Japanese Patent Application No. 2024-033160, filed on 5 Mar. 2024, the content of which is incorporated herein by reference.

### BACKGROUND OF THE INVENTION

### Field of the Invention

The present invention relates to an electrical connection structure for electrically connecting a plurality of members.

### Related Art

In the internal structure of electrical equipment, there are the following such configurations. More specifically, predetermined circuit units are mounted on a machine base. The plus terminal of this circuit unit is electrically connected to the plus terminal of a capacitor unit. In addition, the minus terminal of this circuit unit is electrically connected to the minus terminal of this capacitor unit.

Patent Document 1: Japanese Unexamined Patent Application, Publication No. 2023-131919

### SUMMARY OF THE INVENTION

For this case, the present inventors have considered further electrically connecting a first bus bar to the plus terminal of the circuit unit and the plus terminal of the capacitor unit. Then, it has been considered to further electrically connect a second bus bar to the minus terminal of the circuit unit and the minus terminal of the capacitor unit.

However, the inventors have focused on the matter of there being the problem shown below in this case. In the case of the height of the capacitor being lower than the height of the circuit unit, it is possible to arrange the first bus bar and the second bus bar above the capacitor rather effortlessly. However, in the case of the height of the capacitor being higher than the height of the circuit unit, it is difficult to arrange the first bus bar and the second bus bar above the capacitor unit.

As a countermeasure to this, a countermeasure has been considered to arrange the first bus bar and the second bus bar between the circuit unit and the capacitor unit. However, in this case, the distance from the circuit unit until the capacitor unit increases. This leads to an increase in parasitic inductance between the circuit unit and the capacitor unit, leading to an increase in size of the capacitor itself.

On the other hand, when forcibly arranging this first bus bar and second bus bar above the capacitor unit, it is necessary to bend the end parts on the circuit unit side of this first bus bar and second bus bar so as to extend from above the capacitor unit until the terminals of this circuit unit. This increases the number of bending presses of the first bus bar and the second bus bar, and is linked to a cost increase.

The present invention has been made taking account of the above situation, and has an object of arranging a first bus bar and a second bus bar above a capacitor unit, without bending so as to extend from above the capacitor unit until the terminals of the circuit unit.

The present inventors found that it is possible to achieve the above-mentioned object if using the collar which is an electric conductor, thereby arriving at the present invention. The present invention is an electrical connection structure of the following first to third aspects.

According to a first aspect of the present invention, an electrical connection structure electrically connects together a predetermined first bus bar with a plus terminal of a circuit unit mounted on a machine base, and a plus terminal of a predetermined capacitor unit, and electrically connects together a predetermined second bus bar with a minus terminal of the predetermined circuit unit, and a minus terminal of the capacitor unit,
in which an upper surface of the capacitor unit is at a position higher than an upper surface of the machine base, the electrical connection structure including:
a first male screw and a second male screw which each project upwards from an end of the machine base adjacent to the capacitor unit;
a first collar which is an electric conductor having female threads at both upper and lower sides thereof, and a lower part thereof being threaded to the first male screw, whereby the first collar is electrically connected to the plus terminal of the circuit unit and the plus terminal of the capacitor unit;
a second collar which is an electric conductor having female threads at both upper and lower sides thereof, and a lower part thereof being threaded to the second male screw, whereby the second collar is electrically connected to the minus terminal of the circuit unit and the minus terminal of the capacitor unit;
a first threaded member which fastens the first bus bar to an upper part of the first collar so that the first bus bar is positioned above the capacitor unit, and electrically connects the first bus bar to the first collar; and
a second threaded member which fastens the second bus bar to an upper part of the second collar so that the second bus bar is positioned above the capacitor unit, and electrically connects the second bus bar to the second collar.

According to the present configuration, it is possible to arrange the first bus bar and the second bus bar above the capacitor unit by the first collars and the second collars. Moreover, due to using these first collars and second collars, it is also unnecessary to bend the first bus bar and the second bus bar so as to extend from above the capacitor unit until the terminals of the circuit unit.

According to the present configuration, it is possible to arrange the first bus bars and the second bus bars above the capacitor unit without bending so as to extend from above the capacitor unit until the terminals of the circuit unit.

According to a second aspect of the present invention, in the electrical connection structure as described in the first aspect, the first male screw and the second male screw are members of the same shape,
the first collar and the second collar are members of the same shape, and
the first threaded member and the second threaded member are members of the same shape.

According to the present configuration, it is possible simply configure the electrical connection structure by curbing the types of members.

According to a third aspect of the present invention, in the electrical connection structure as described in the first or second aspect, the circuit unit includes a part of a drive circuit that drives a drive motor of a vehicle, and
the capacitor unit includes a smoothing capacitor of the drive circuit.

According to the present configuration, the above effects can be obtained in a drive circuit that drives a drive motor.

As shown above, according to the configuration of the first aspect, the first bus bar and the second bus bar are arranged above the capacitor unit, without bending to extend from above the capacitor unit to the terminals of the circuit unit. Furthermore, according to the configurations of the second and third aspects, each additional effect is obtained.

### BRIEF DESCRIPTION OF THE DRAWINGS

FIG. 1 is a perspective view showing an electrical connection structure and its periphery according to a first embodiment;

FIG. 2 is a front view showing the electrical connection structure;

FIG. 3 is a view showing a cross section along a line fg3-fg3 in FIG. 1;

FIG. 4 is a circuit diagram showing an electrical connection structure and its periphery; and

FIG. 5 is a perspective view showing an electrical connection structure and its periphery according to a comparative example.

### DETAILED DESCRIPTION OF THE INVENTION

Hereinafter, an embodiment of the present invention will be described while referencing the drawings. However, the present invention is not to be limited in any way to the below embodiment, and can be implemented by modifying as appropriate within a scope not departing from the gist of the present invention.

### First Embodiment

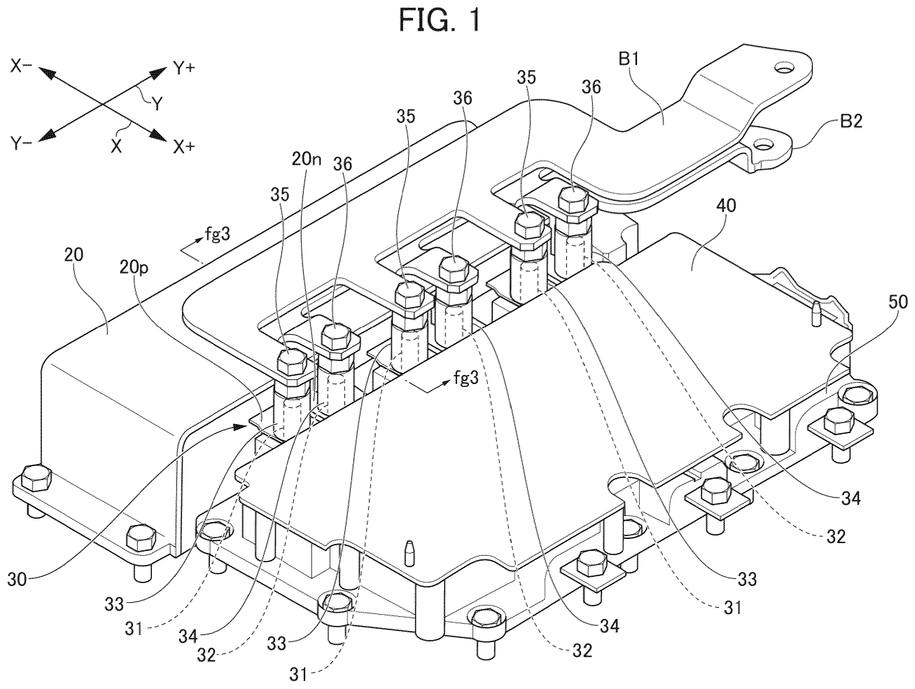

As shown in FIG. 1, an electrical connection structure 30 of the present embodiment is mainly configured by six collars 33 and 34. The six collars 33 and 34 consist of three first collars 33 and three second collars 34. The three first collars 33 electrically connect a plus terminal 40p of a circuit unit 40, a plus terminal 20p of the capacitor unit 20 and a first bus bar B1 to each other. The three second collars 34 electrically connect a minus terminal 40n of the circuit unit 40, a minus terminal 20n of the capacitor unit 20 and a second bus bar B2 to each other.

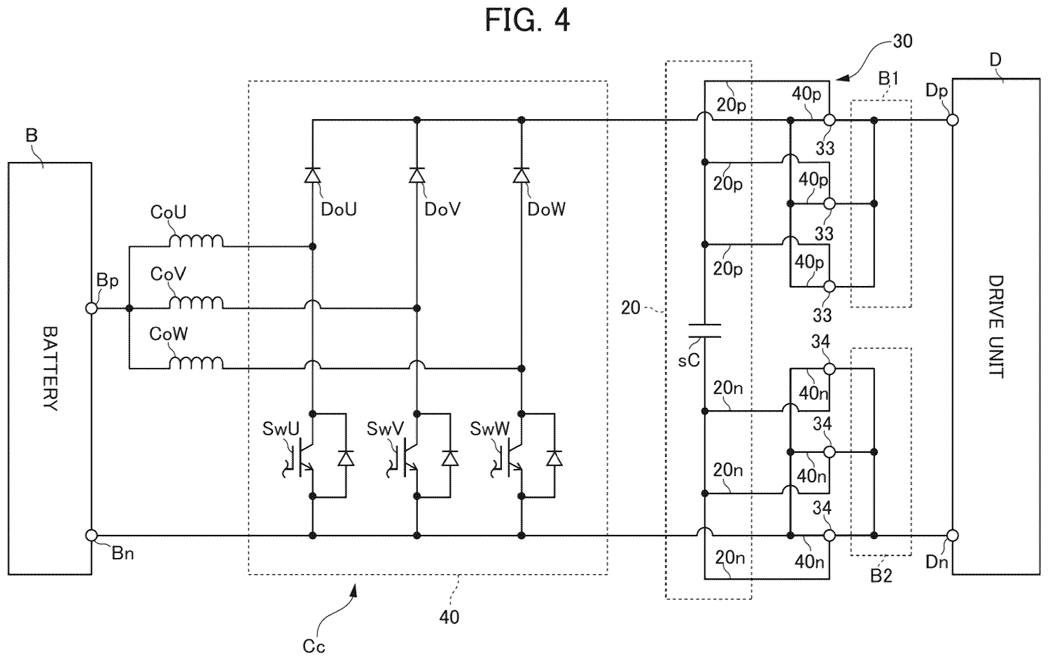

As shown in FIG. 4, the circuit unit 40 includes part of a voltage conversion circuit Cc which converts the voltage. The capacitor unit 20 includes a smoothing capacitor sC of this voltage conversion circuit Cc. The voltage conversion circuit Cc boosts the voltage supplied from a battery B, and supplies this to a drive unit D. The voltage conversion circuit Cc and a circuit in the drive unit D are both parts of a driving circuit which drives a drive motor of a vehicle.

The voltage conversion circuit Cc includes coils of three phases CoU, CoV, CoW, three semiconductor switches SwU, SwV, SwW, three diodes DoU, DoV, DoW, and a smoothing capacitor sC. A portion of this voltage conversion circuit Cc which includes the three semiconductor switches SwU, SwV and SwW, and the three diodes DOU, DoV and DoW constitutes the circuit of the aforementioned circuit unit 40.

The three-phase coils CoU, CoV and CoV consist of a U-phase coil CoU, a V-phase coil CoV and a W-phase coil CoW. The three semiconductor switches SwU, SwV and SwW consist of a U-phase switch SwU, a V-phase switch SwV and a W-phase switch SwW. The three diodes DOU, DoV and DoW consist of a U-phase diode DoU, a V-phase diode and a W-phase diode DoW.

One end of each of the three coils CoU, CoV and CoW is electrically connected to the plus terminal Bp of the battery B. The other end of the U-phase coil CoU is electrically connected to an anode terminal of the U-phase diode DoU, and electrically connected to a plus terminal of the U-phase switch SwU. The other end of the V-phase coil CoV is electrically connected to an anode terminal of the V-phase diode DoV, and electrically connected to a plus phase of the V-phase switch SwV. The other end of the W-phase coil Cow is electrically connected to an anode terminal of the W-phase diode DoW, and electrically connected to a plus terminal of the W-phase switch SwW.

The cathode terminals of the three diodes DOU, DoV and DoW are respectively electrically connected to the three first collars 33 via three parallel plus terminals 40p on the output side of the circuit unit 40.

The minus terminals of the three semiconductor switches SwU, SwV, SwW are electrically connected to the minus terminal Bn of the battery B, and respectively electrically connected to the three second collars 34 via three parallel minus terminals 40n on the output side of the circuit unit 40.

The plus terminal of the smoothing capacitor sC is electrically connected via the three parallel plus terminals 20p of the capacitor unit 20 to the three first collars 33. The minus terminal of the smoothing capacitor sC is electrically connected via the three parallel minus terminals 20n of the capacitor unit 20 to the three second collars 34.

Furthermore, the plus terminal Dp of the drive unit D is electrically connected via the first bus bar B1 to the three first collars 33. Furthermore, the minus terminal Dn of the drive unit D is electrically connected via the second bus bar B2 to the three second collars 34.

Hereinafter, as shown in FIG. 1, two predetermined directions which are orthogonal to each other within the horizontal plane are referred as “X direction” and “Y direction”. In addition, one side in the X direction is referred to as “X− side”, and the opposite side thereto is referred to as “X+ side”. In addition, one side in the Y direction is referred to as “Y− side”, and the opposite side thereto is referred to as “Y+ side”.

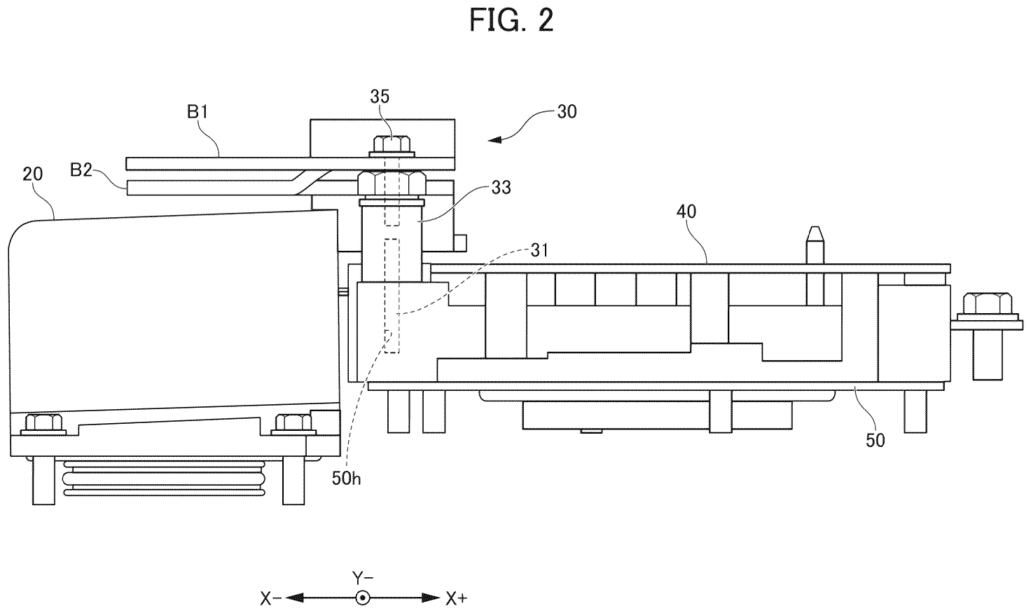

As shown in FIG. 2, the circuit unit 40 is mounted on the top surface of a machine base 50. The capacitor unit 20 is provided more to the X− side than the machine base 50. The top surface of the capacitor unit 20 is at a position higher than the top surface of the machine base 50.

The electrical connection structure 30 shown in FIG. 1 includes six male screws 31 and 32, and six threaded members 35 and 36, in addition to the aforementioned six collars 33 and 34. The six male screws 31 and 32 consist of three first male screws 31, and three second male screws 32. The six threaded members 35 and 36 consist of three first threaded members 35 and three second threaded members 36.

Each of the first male screws 31 and each of the second male screws 32 are members of the same shape. Each of the first collars 33 and each of the second collars 34 are members of the same shape. Each of the first threaded members 35 and each of the second threaded members 36 are members of the same shape.

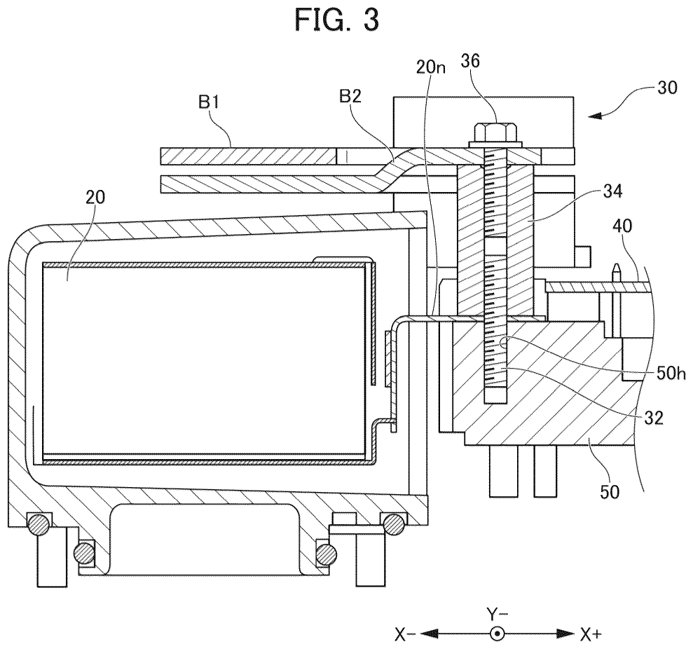

The six male screws 31 and 32 are provided along the Y direction at the end on the X− side of the machine base 50. More specifically, the first male screw 31 and the second male screw 32 are alternately arranged in the Y direction. As shown in FIGS. 2 and 3, each of the male screws 31 and 32 projects upwards from the machine base 50, by respectively being threaded into female screw holes 50h provided in the machine base 50.

As shown in FIG. 3, each of the six collars 33 and 34 are all electric conductors having female threads on both top and bottom sides.

As shown in FIG. 1, the lower part of each of the first collars 33 is threaded with the first male screw 31 corresponding to this first collar 33. As shown in FIG. 4, the three parallel plus terminals 40p on the output side of the circuit unit 40 are thereby electrically connected to the three first collars 33.

As shown in FIG. 1, the lower part of each of the second collars 34 is threaded to the second male screws 32 corresponding to this second collar 34. As shown in FIG. 4, the three parallel minus terminals 40n on the output side of the circuit unit 40 are thereby electrically connected to the three second collars 34.

As shown in FIG. 1, between each of the first collars 33 and the machine base 50, the plus terminal 20p corresponding to this first collar 33 of the capacitor unit 20 is interposed. As shown in FIG. 4, the three parallel plus terminals 20p of the capacitor unit 20 are thereby electrically connected to the three first collars 33.

As shown in FIG. 1, between each of the second collars 34 and the machine base 50, the minus terminal 20n corresponding to this second collar 34 of the capacitor unit 20 is interposed. As shown in FIG. 4, the three parallel minus terminals 20n of the capacitor unit 20 are thereby electrically connected to the three second collars 34.

As shown in FIG. 1, to the upper end of each one of the first collars 33, a portion corresponding to this first collar 33 of the first bus bar B1 is mounted by the first threaded member 35. The first bus bar B1 is thereby electrically connected to the three first collars 33, and this first bus bar B1 is installed above the capacitor unit 20.

To the upper end of each one of the second collars 34, a portion corresponding to this second collar 34 of the second bus bar B2 is mounted by the second threaded member 36. The second bus bar B2 is thereby electrically connected to the three second collars 34, and this second bus bar B2 is installed above the capacitor unit 20.

More specifically, directly above the capacitor unit 20, the second bus bar B2 is installed with a space from the capacitor unit 20. Directly above this second bus bar B2, the first bus bar B1 is installed with a space from the second bus bar B2.

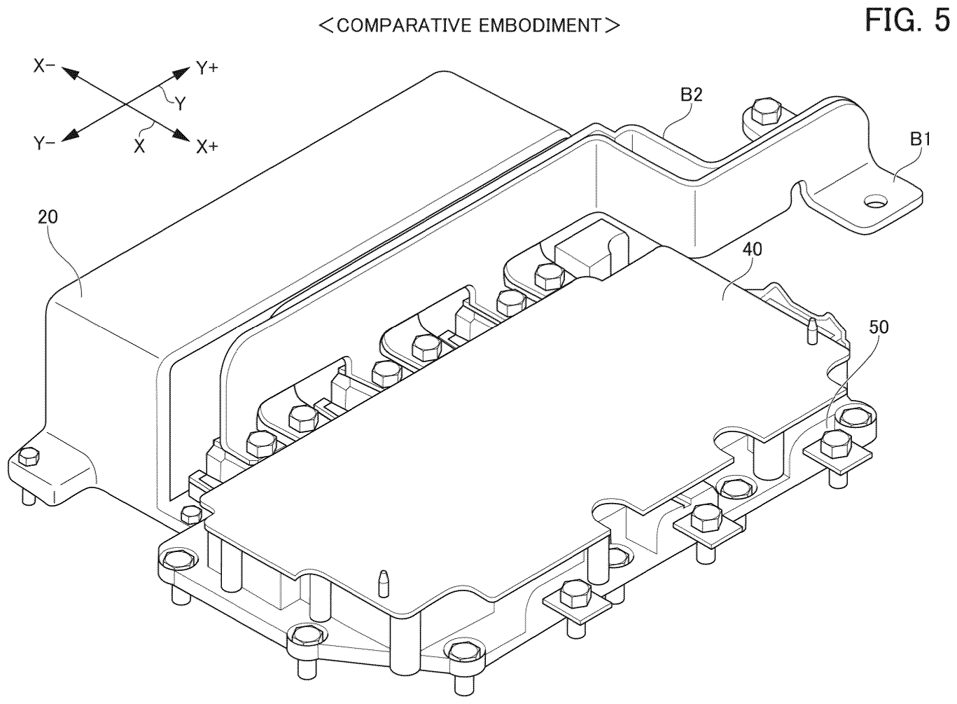

Hereinafter, an embodiment made by eliminating the electrical connection structure 30 from the form of the present embodiment shown in FIG. 1, and then arranging the first bus bar B1 and the second bus bar B2 between the circuit unit 40 and the capacitor unit 20 as shown in FIG. 5 is referred to as “comparative embodiment”.

Hereinafter, the configuration and effects of the present embodiment will be summarized while comparing with the comparative embodiment.

As shown in FIG. 1, in the present embodiment, by the first bus bar B1 being fastened by the first threaded member 35 to the upper end of the first collar 33, the first bus bar B1 is installed above the capacitor unit 20. In addition, by the second bus bar B2 being fastened by the second threaded member 36 to the upper end of the second collar 34, the second bus bar B2 is installed above the capacitor unit 20. For this reason, it is possible to arrange the first bus bar B1 and the second bus bar B2 above the capacitor unit 20 by these first collars 33 and second collars 34.

For this reason, as in the comparative example shown in FIG. 5, it is not necessary to arrange this first bus bar B1 and second bus bar B2 between the capacitor unit 20 and the circuit unit 40. For this reason, in the present embodiment shown in FIG. 1, it is possible to shorten the distance in the X direction from the circuit unit 40 to the capacitor unit 20. For this reason, the entire assembly including the circuit unit 40, the capacitor unit 20, the first bus bar B1 and the second bus bar B2 can be assembled compactly in the X direction.

In addition, by the distance between the circuit unit 40 and the capacitor unit 20 becoming shorter in this way, it is possible to achieve a reduction in parasitic inductance therebetween. It is thereby possible to achieve a size reduction in the capacitor unit 20, and also in this respect, it is possible to achieve a size reduction and weight reduction in the assembly overall, which is linked to improved consumption efficiency. Furthermore, by the distance between the circuit unit 40 and the capacitor unit 20 becoming shorter in this way, it is also possible to achieve a reduction in electric resistance therebetween, and this is also linked to improved consumption efficiency.

Moreover, due to using the first collars 33 and the second collars 34, it is also unnecessary to bend the first bus bar B1 and the second bus bar B2 so as to extend from above the capacitor unit 20 until the terminals of the circuit unit 40. Based on this, the number of bending presses of the first bus bar B1 and the second bus bar B2 decreases, and thus a cost decrease is achieved.

As shown in FIG. 1, each of the first male screws 31 and each of the second male screws 32 are members of the same shape. Each of the first collars 33 and each of the second collars 34 are members of the same shape. Each of the first threaded members 35 and each of the second threaded members 36 are members of the same shape. Based on the above, it is possible simply configure the electrical connection structure 30 by curbing the types of members.

The circuit unit 40 and capacitor unit 20 are parts of the drive circuit which drives the drive motor of the vehicle. For this reason, according to the present embodiment, this drive circuit can be compactly assembled in the X direction.

### Other Embodiments

The embodiment shown above can be modified as follows, for example.

The numbers of the first male screws 31, the first collars 33 and first threaded members 35 shown in FIG. 1 may be set to 2 or less of each, or may be set to 4 or more of each. Similarly, the numbers of the second male screws 32, the second collars 34 and the second threaded members 36 may be set to 2 or less of each, or may be set to 4 or more of each.

In place of part of the voltage conversion circuit Cc, the circuit unit 40 may include a part of a predetermined circuit such as an inverter circuit, for example. Then, in place of the smoothing capacitor sC constituting a part of the voltage conversion circuit Cc, the capacitor unit 20 may include a capacitor constituting a part of this predetermined circuit.

### EXPLANATION OF REFERENCE NUMERALS

20 capacitor unit
30 electrical connection structure
31 first male screw
32 second male screw
33 first collar
34 second collar
35 first threaded member
36 second threaded member
40 circuit unit
50 machine base
B1 first bus bar
B2 second bus bar
sC smoothing capacitor

What is claimed is:

1. An electrical connection structure which electrically connects together a predetermined first bus bar with a plus terminal of a circuit unit mounted on a machine base, and a plus terminal of a predetermined capacitor unit, and electrically connects together a predetermined second bus bar with a minus terminal of the predetermined circuit unit, and a minus terminal of the capacitor unit,
wherein an upper surface of the capacitor unit is at a position higher than an upper surface of the machine base, the electrical connection structure comprising:
a first male screw and a second male screw which each project upwards from an end of the machine base adjacent to the capacitor unit;
a first collar which is an electric conductor having female threads at both upper and lower sides thereof, and a lower part thereof being threaded to the first male screw, whereby the first collar is electrically connected to the plus terminal of the circuit unit and the plus terminal of the capacitor unit;
a second collar which is an electric conductor having female threads at both upper and lower sides thereof, and a lower part thereof being threaded to the second male screw, whereby the second collar is electrically connected to the minus terminal of the circuit unit and the minus terminal of the capacitor unit;
a first threaded member which fastens the first bus bar to an upper part of the first collar so that the first bus bar is positioned above the capacitor unit, and electrically connects the first bus bar to the first collar; and
a second threaded member which fastens the second bus bar to an upper part of the second collar so that the second bus bar is positioned above the capacitor unit, and electrically connects the second bus bar to the second collar.

2. The electrical connection structure according to claim 1,
wherein the first male screw and the second male screw are members of the same shape,
wherein the first collar and the second collar are members of the same shape, and
wherein the first threaded member and the second threaded member are members of the same shape.

3. The electrical connection structure according to claim 1, wherein the circuit unit includes a part of a drive circuit that drives a drive motor of a vehicle, and
wherein the capacitor unit includes a smoothing capacitor in the drive circuit.
